(19) United States
(12) Patent Application Publication
(10) Pub. No.: US 2026/0157286 A1
(43) Pub. Date: Jun. 11, 2026

(54) BALE IDENTIFICATION SYSTEM FOR AN AGRICULTURAL HARVESTER

(71) Applicants: CNH Industrial America LLC, New Holland, PA (US); CNH Industrial Canada, Ltd., Saskatoon (CA)

(72) Inventors: Cale Boriack, Lititz, PA (US); Steven Alexander Iseman, Akron, PA (US); Martin J. Roberge, Quebec (CA)

(21) Appl. No.: 19/409,952

(22) Filed: Dec. 5, 2025

Related U.S. Application Data
(60) Provisional application No. 63/728,748, filed on Dec. 6, 2024.

(51) Int. Cl. A01F 15/07

(52) U.S. Cl. CPC A01F 15/071; A01F 2015/076

(57) ABSTRACT

A bale identification system of an agricultural harvester includes a controller that receives a bale wrap assembly code from a bale wrap assembly scanner. The bale wrap assembly code includes a bale wrap assembly identification code and a bale wrap segment end index. The controller also determines a respective bale wrap segment index for each bale wrap segment of the bale wrap assembly based on the bale wrap segment end index and an order of bale wrap segment usage. Furthermore, the controller establishes a database having multiple entries. Each entry corresponds to a respective bale wrap segment, and each entry includes the bale wrap assembly identification code, the respective bale wrap segment index, and bale wrap segment information.

### CROSS-REFERENCE TO RELATED APPLICATION

This application claims priority from and the benefit of U.S. Provisional Application Ser. No. 63/728,748, entitled “BALE IDENTIFICATION SYSTEM FOR AN AGRICULTURAL HARVESTER”, filed Dec. 6, 2024, which is hereby incorporated by reference in its entirety.

### BACKGROUND

Agricultural harvesters are used to harvest agricultural product (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. By way of further example, the agricultural harvester may include a pickup mechanism configured to feed the agricultural product from the ground to the baler. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale. Numerous bales may be wrapped during this process and, as such, the bales need to be properly identified.

Accordingly, there is a need for a mechanism that enables efficient identification of the bales.

### BRIEF DESCRIPTION

In certain embodiments, a bale identification system for an agricultural harvester includes a controller having a processor and a memory. The controller receives a bale wrap assembly code from a bale wrap assembly scanner. The bale wrap assembly scanner scans a bale wrap assembly identifier of a bale wrap assembly, the bale wrap assembly identifier includes data indicative of the bale wrap assembly code, and the bale wrap assembly code includes a bale wrap assembly identification code and a bale wrap segment end index. The controller also determines a respective bale wrap segment index for each bale wrap segment of the bale wrap assembly based on the bale wrap segment end index and an order of bale wrap segment usage. Furthermore, the controller establishes a database having multiple entries. Each entry corresponds to a respective bale wrap segment, and each entry includes the bale wrap assembly identification code, the respective bale wrap segment index, and bale wrap segment information. The database enables a remote system to retrieve the bale wrap segment information based on a bale wrap segment code received from a bale wrap scanner of the remote system, and the bale wrap segment code includes the bale wrap assembly identification code and the respective bale wrap segment index.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having an agricultural product transport assembly and a baler.

FIG. 2 is a schematic view of an embodiment of an agricultural product transport assembly and an embodiment of a baler that may be employed within the agricultural harvester of FIG. 1.

FIG. 3 is a block diagram of an embodiment of a bale identification system that may be employed within the baler of FIG. 2.

FIG. 4 is a table of an embodiment of a database that may be established by the bale identification system of FIG. 3.

FIG. 5 is a table of another embodiment of a database that may be established by the bale identification system of FIG. 3.

FIG. 6 is a flow diagram of an embodiment of a method for facilitating bale identification.

FIG. 7 is a flow diagram of another embodiment of a method for facilitating bale identification.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

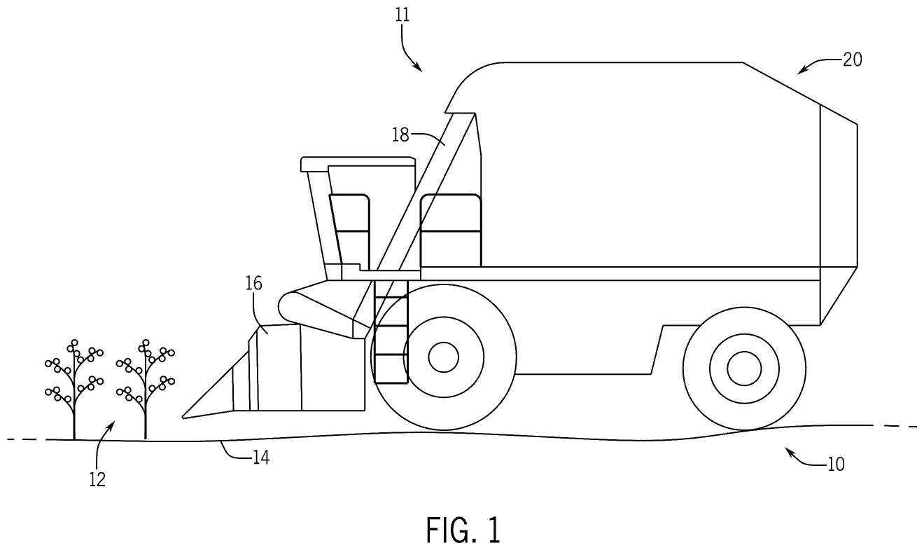

FIG. 1 is a side view of an embodiment of an agricultural harvester 10 (e.g., harvester, agricultural harvester, etc.) having an agricultural product transport assembly 11 and a baler. The agricultural harvester 10 harvests agricultural product 12 (e.g., cotton) from a field 14 and forms the agricultural product 12 into bales (e.g., agricultural bales). In the illustrated embodiment, the agricultural harvester 10 includes a header 16 having row units that harvest the agricultural product 12 from the field 14. Additionally, the agricultural product transport assembly 11 of the agricultural harvester 10 includes an air-assisted conveying system 18 that moves the agricultural product 12 from the row units of the header 16 to an accumulator assembly of the agricultural product transport assembly 11. The agricultural product transport assembly 11 also includes a conveying system that conveys the agricultural product 12 from the accumulator assembly into the baler 20 (e.g., agricultural baler). The baler 20 is supported by and/or mounted within or on a chassis of the agricultural harvester 10. The baler 20 may form the agricultural product 12 into round bales. However, in other embodiments, the baler 20 of the agricultural harvester 10 may form the agricultural product into square bales, polygonal bales, or bales of other suitable shape(s). After forming the agricultural product 12 into a bale, a bale wrapping system of the agricultural harvester 10 wraps the bale with a bale wrap to secure the agricultural product 12 within the bale and to generally maintain a shape of the bale.

In certain embodiments, the agricultural harvester includes a bale identification system having a controller with a processor and a memory. The controller receives a bale wrap assembly code from a bale wrap assembly scanner. The bale wrap assembly scanner scans a bale wrap assembly identifier of a bale wrap assembly, the bale wrap assembly identifier includes data indicative of the bale wrap assembly code, and the bale wrap assembly code includes a bale wrap assembly identification code (e.g., which uniquely identifies the bale wrap assembly) and a bale wrap segment end index (e.g., corresponding to a bale wrap segment index of the first or last bale wrap segment of the bale wrap assembly). Furthermore, the controller determines a respective bale wrap segment index for each bale wrap segment of the bale wrap assembly based on the bale wrap segment end index and an order of bale wrap segment usage. In addition, the controller establishes a database having multiple entries, in which each entry corresponds to a respective bale wrap segment, and each entry includes the bale wrap assembly identification code, the respective bale wrap segment index, and bale wrap segment information. The database enables a remote system to retrieve the bale wrap segment information based on a bale wrap segment code received by a bale wrap scanner of the remote system, and the bale wrap segment code includes the bale wrap assembly identification code and the respective bale wrap segment index. Accordingly, the bale identification system associates the bale wrap segment information with the respective bale wrap segment without scanning a bale wrap identifier on the respective bale wrap segment, in which the bale wrap identifier includes data indicative of the bale wrap segment code. As a result, a bale wrap scanner within the agricultural harvester is obviated.

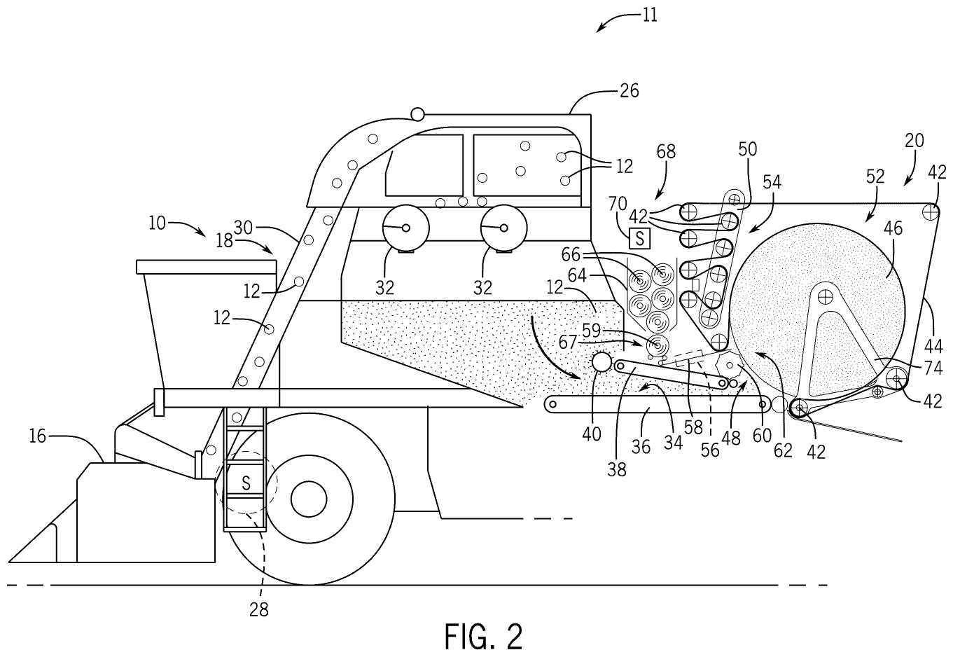

FIG. 2 is a schematic view of an embodiment of an agricultural product transport assembly 11 and an embodiment of a baler 20 that may be employed within the agricultural harvester 10 of FIG. 1. As previously discussed, the header 16 of the agricultural harvester 10 includes row units that harvest the agricultural product 12 (e.g., cotton, hay, straw, fodder) from the field. Furthermore, the air-assisted conveying system 18 moves the agricultural product 12 from the row units of the header 16 to the accumulator assembly 26. In the illustrated embodiment, the air-assisted conveying system 18 includes a conveying air source 28 that outputs a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 that distribute the agricultural product 12 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport assembly 11 includes a first belt (e.g., belt) 36 that moves the agricultural product 12 from the accumulator assembly 26 to the baler 20. The first belt 36 rotates in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 cooperates with the first belt 36 to move the agricultural product 12 from the accumulator assembly 26 to the baler 20. Furthermore, in the illustrated embodiment, the conveying system 34 includes an agitation roller 40 positioned upstream of the second belt 38. The agitation roller 40 agitates the agricultural product 12 entering the pair of opposing belts, thereby enhancing the uniformity of the distribution of the agricultural product passing through the pair of opposing belts.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 that establishes tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 of an active bale wrap assembly 59 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be in the form of a plastic film, an organic film, a net, a series of twine segments, or any other suitable structure. The bale wrap 58 may be fed into contact with the bale 46 using one or more rollers and/or one or more belts of a bale wrap feeding assembly. The roller(s) and/or the belt(s) drive the bale wrap 58 toward a starter roller 60 (e.g., bale wrap feeder). The starter roller 60 rotates to feed the bale wrap 58 into the cavity 48 of the baler 20 at a feeding location 62, thereby driving the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated. While the starter roller 60 feeds the bale wrap 58 into the cavity 48 in the illustrated embodiment, in other embodiments, the agricultural harvester may include another suitable bale wrap feeder that feeds the bale wrap into the cavity. For example, in certain embodiments, the agricultural harvester may include a movable wrap guide (e.g., duck bill) that engages the bale wrap while the movable wrap guide is in a first position and moves to a second position to feed the bale wrap into the cavity at the feeding location.

In the illustrated embodiment, the agricultural harvester 10 includes a bale wrap assembly storage compartment 64 that stores multiple bale wrap assemblies 66. In certain embodiments, each bale wrap assembly 66 includes a shaft and a bale wrap disposed about the shaft to form a roll of the bale wrap. However, in other embodiments, the shaft may be omitted, and the bale wrap of the bale wrap assembly may be arranged in a roll (e.g., with a hollow region at the center). Furthermore, in certain embodiments, the agricultural harvester includes a bale wrap assembly transport system that moves a bale wrap assembly 66 from the bale wrap assembly storage compartment 64 (e.g., at the bottom of the bale wrap assembly storage compartment 64) into a usage location 67. The bale wrap assembly within the usage location 67 becomes the active bale wrap assembly 59, and, as discussed above, the bale wrap 58 of the active bale wrap assembly 59 is fed into contact with the bale 46 to wrap the bale 46.

The bale wrap assemblies 66 may be loaded into the bale wrap assembly storage compartment 64 via an opening at the top of the bale wrap assembly storage compartment 64. For example, a crane may move each bale wrap assembly 66 from a ground surface to the bale wrap assembly storage compartment 64 by lifting the bale wrap assembly 66 upwardly, moving the bale wrap assembly to a position over the opening at the top of the bale wrap assembly storage compartment, and lowering the bale wrap assembly into the bale wrap assembly storage compartment. Furthermore, in certain embodiments, the bale wrap assemblies may be loaded into the bale wrap assembly storage compartment manually. While the agricultural harvester 10 includes a bale wrap assembly storage compartment 64 that stores multiple bale wrap assemblies 66 in the illustrated embodiment, in other embodiments, the bale wrap assembly storage compartment may store a single bale wrap assembly. Furthermore, in certain embodiments, the bale wrap assembly storage compartment may be omitted. In such embodiments, the bale wrap assembly (e.g., the active bale wrap assembly) may be loaded directly into the usage location (e.g., manually, via a crane, etc.).

Each bale 46 is wrapped with a segment of the bale wrap 58 of the active bale wrap assembly 59. In certain embodiments, the bale wrap 58 of each bale wrap assembly is segmented. In certain embodiments, segmented bale wraps include multiple bale wrap segments that may each wrap a respective bale, and weakened sections that may each be positioned between adjacent bale wrap segments to facilitate separation of the bale wrap segments. In such embodiments, in response to determining the weakened section of the bale wrap 58 being positioned between the shaft/center hollow region of the active bale wrap assembly 59 and the bale 46, the bale wrapping system 56 controls a braking system to establish a tension force at the weakened section of the bale wrap 58 sufficient to separate a first segment of the bale wrap disposed about the bale 46 from a second segment of the bale wrap 58 disposed about the shaft/center hollow region of the active bale wrap assembly 59, thereby facilitating completion of the bale wrapping process and ejection of the wrapped bale. Furthermore, in certain embodiments, the bale wrap 58 of each bale wrap assembly is continuous. In such embodiments, in response to determining an interface between an end of a first segment and a beginning of a second segment being positioned at a cutting system (e.g., by identifying a cut location indicator on the bale wrap), the bale wrapping system 56 controls the cutting system to separate the first segment (which may be disposed about the bale 46) from the second segment (which may be disposed about the shaft/center hollow region of the active bale wrap assembly 59), thereby facilitating completion of the bale wrapping process and ejection of the wrapped bale.

Each bale wrap assembly 66 includes a bale wrap assembly identifier that facilitates identification of the bale wrap assembly. In certain embodiments, the bale wrap assembly identifier includes an image disposed on the shaft of the bale wrap assembly. For example, the image may be printed directly onto the shaft, the image may be engraved into the shaft, or the image may be printed onto a sticker applied to the shaft. The image may include any suitable image (e.g., bar code, quick response (QR) code, data matrix, etc.) that may be scanned by a suitable scanner (e.g., bar code scanner, QR code scanner, data matrix scanner, etc.). Furthermore, in certain embodiments, the bale wrap assembly identifier may include a radio frequency identification (RFID) tag disposed on or in the shaft of the bale wrap assembly. Each bale wrap assembly identifier includes data indicative of a bale wrap assembly code. The bale wrap assembly code includes a bale wrap assembly identification code, which may uniquely identify the respective bale wrap assembly or uniquely identify the respective bale wrap assembly within a set of bale wrap assemblies. In certain embodiments, each bale wrap assembly 66 may include multiple bale wrap assembly identifiers, each having data indicative of the same bale wrap assembly code.

In the illustrated embodiment, the agricultural harvester 10 includes a bale identification system 68 having a bale wrap assembly scanner 70 that scans each bale wrap assembly identifier. The bale wrap assembly scanner 70 scans the bale wrap assembly identifier on each bale wrap assembly 66. In the illustrated embodiment, the bale wrap assembly scanner 70 may be positioned at a location within the agricultural harvester 10 to scan the bale wrap assembly identifier as the bale wrap assembly 66 is loaded into the bale wrap assembly storage compartment 64 (e.g., proximate to the opening at the top of the bale wrap assembly storage compartment 64). In embodiments in which the bale wrap assembly storage compartment is omitted, the bale wrap assembly scanner 70 may be positioned proximate to the usage location 67, thereby enabling the bale wrap assembly scanner 70 to scan the bale wrap assembly identifier as the active bale wrap assembly 59 is loaded into the usage location 67. Furthermore, in certain embodiments, the bale wrap assembly scanner may be located at any other suitable location within the agricultural harvester to scan each bale wrap assembly identifier. In addition, in certain embodiments, the bale identification system may include multiple bale wrap assembly scanners at multiple locations within the agricultural harvester. Furthermore, in certain embodiments, the bale wrap assembly scanner 70 may not be coupled to the agricultural harvester. For example, the bale wrap assembly scanner 70 may be part of a handheld device (e.g., mobile phone, tablet, etc.) that an operator may use to scan the bale wrap assembly identifier.

The bale wrap assembly scanner 70 may include any suitable device(s) suitable for scanning the bale wrap assembly identifiers. For example, in embodiments in which each bale wrap assembly identifier includes an image (e.g., bar code, QR code, data matrix), the bale wrap assembly scanner 70 may include an optical scanner. Furthermore, in embodiments in which each bale wrap assembly identifier includes an RFID tag, the bale wrap assembly scanner 70 may include an RFID reader. As previously discussed, each bale wrap assembly identifier includes data indicative of a respective bale wrap assembly code. In response to scanning each bale wrap assembly identifier, the bale wrap assembly scanner 70 outputs the respective bale wrap assembly code (e.g., a signal indicative of the respective bale wrap assembly code).

Furthermore, as discussed in detail below, the bale identification system 68 includes a controller communicatively coupled to the bale wrap assembly scanner 70. The controller includes a processor an a memory, and the controller receives the bale wrap assembly code from the bale wrap assembly scanner 70. As previously discussed, the bale wrap assembly code includes the bale wrap assembly identification code, which may uniquely identify the respective bale wrap assembly or uniquely identify the respective bale wrap assembly within a set of bale wrap assemblies. In addition, the bale wrap assembly code includes a bale wrap segment end index. A bale wrap segment index may be associated with each bale wrap segment of the bale wrap of the bale wrap assembly. The bale wrap segment end index may correspond to the bale wrap segment index of the first bale wrap segment (e.g., outermost bale wrap segment) or the last bale wrap segment (e.g., innermost bale wrap segment).

The controller determines the respective bale wrap segment index for each bale wrap segment of the bale wrap of the bale wrap assembly based on the bale wrap segment end index and an order of bale wrap segment usage. For example, if the bale wrap segment end index corresponds to the bale wrap segment index of the first bale wrap segment, the controller may determine the bale wrap segment index of the first bale wrap segment is the bale wrap segment end index, the bale wrap segment index of the second bale wrap segment is the bale wrap segment end index incremented by one, the bale wrap segment index of the third bale wrap segment is the bale wrap segment end index incremented by two, and so forth. Furthermore, if the bale wrap segment end index corresponds to the bale wrap segment index of the last bale wrap segment, the controller may determine the bale wrap segment index of the first bale wrap segment is the bale wrap segment end index decremented by one less than the number of bale wrap segments of the bale wrap, the bale wrap segment index of the second bale wrap segment is the bale wrap segment end index decremented by two less than the number of bale wrap segments of the bale wrap, and so forth.

In addition, the controller establishes a database having multiple entries. Each entry of the database corresponds to a respective bale wrap segment, and each entry includes the bale wrap assembly identification code for the respective bale wrap assembly (e.g., the bale wrap assembly having the respective bale wrap segment), the respective bale wrap segment index, and bale wrap segment information. The bale wrap segment information may include the type of bale wrap (e.g., segmented or continuous), the form of the bale wrap (e.g., plastic film, organic film, net, series of twine segments, etc.), the length of the bale wrap segment, the width of the bale wrap segment, the thickness of the bale wrap material, one or more other suitable properties of the bale wrap segment, or a combination thereof. The database enables a remote system to retrieve the bale wrap segment information based on a bale wrap segment code received from a bale wrap scanner of the remote system. The bale wrap segment code may include the bale wrap assembly identification code and the respective bale wrap segment index. Accordingly, the bale identification system 68 associates the bale wrap segment information with the respective bale wrap segment without scanning a bale wrap identifier on the respective bale wrap segment, in which the bale wrap identifier includes data indicative of the bale wrap segment code. As a result, a bale wrap scanner within the agricultural harvester is obviated.

In certain embodiments, the bale wrap assembly code does not include the bale wrap segment end index. In such embodiments, the controller receives the bale wrap assembly code from the bale wrap assembly scanner 70, and the bale wrap assembly code includes the bale wrap assembly identification code. In addition, the controller establishes a database having multiple entries. Each entry corresponds to a respective bale wrap segment, and each entry includes the bale wrap assembly identification code for the respective bale wrap assembly (e.g., the bale wrap assembly having the respective bale wrap segment), the bale wrap segment information, and at least one of an ejection time of the bale wrapped with the respective bale wrap segment or a location of ejection of the bale wrapped with the respective bale wrap segment. The database is sorted by the ejection time or the location of ejection. The database enables the remote system to retrieve the bale wrap segment information based on the bale wrap segment code received from the bale wrap scanner of the remote system. The bale wrap segment code includes the bale wrap assembly identification code and a respective bale wrap segment index, and the bale wrap segment index corresponds to an order of the entries of the database. Accordingly, the bale identification system 68 associates the bale wrap segment information with the respective bale wrap segment without scanning a bale wrap identifier on the respective bale wrap segment, in which the bale wrap identifier includes data indicative of the bale wrap segment code. As a result, a bale wrap scanner within the agricultural harvester is obviated.

For example, in certain embodiments, each entry of the database includes the ejection time of the bale wrapped with the respective bale wrap segment, and the database is sorted by the ejection time. In such embodiments, the first entry in the database corresponds to the first bale wrap segment because the bale wrapped with the first bale wrap segment is ejected first, the second entry in the database corresponds to the second bale wrap segment because the bale wrapped with the second bale wrap segment is ejected second, and so forth. Furthermore, in certain embodiments, each entry of the database includes the location of ejection of the bale wrapped with the respective bale wrap segment, and the database is sorted by location of ejection. In such embodiments, the database may be sorted by the location of ejection based on a path of the agricultural harvester through the field. Accordingly, the first entry in the database corresponds to the first bale wrap segment because the bale wrapped with the first bale wrap segment is the first bale along the path, the second entry in the database corresponds to the second bale wrap segment because the bale wrapped with the second bale wrap segment is the second bale along the path, and so forth.

While the bale identification system is disclosed herein with regard to an agricultural harvester having a header, an air-assisted conveying system, an accumulator, and a conveying system, in certain embodiments, the bale identification system may be employed within another suitable type of agricultural harvester. For example, in certain embodiments, the agricultural harvester may include a pickup mechanism that feeds the agricultural product from the ground to the baler. In such embodiments, the header, the air-assisted conveying system, the accumulator, and the conveying system may be omitted.

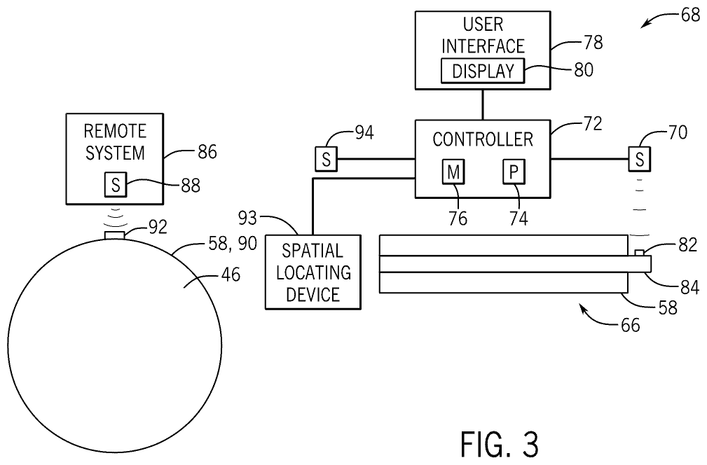

FIG. 3 is a block diagram of an embodiment of a bale identification system 68 that may be employed within the baler of FIG. 2. In the illustrated embodiment, the bale identification system 68 may include a controller 72 communicatively coupled to the bale wrap assembly scanner 70. In certain embodiments, the controller 72 is an electronic controller having electrical circuitry that receives the bale wrap assembly code (e.g., a signal indicative of the bale wrap assembly code) from the bale wrap assembly scanner 70. In the illustrated embodiment, the controller 72 includes a processor 74, such as a microprocessor, and a memory device 76. The controller 72 may also include one or more storage devices and/or other suitable components. The processor 74 may be used to execute software, such as software for receiving the bale wrap assembly code from the bale wrap assembly scanner 70, and so forth. Moreover, the processor 74 may include multiple microprocessors, one or more “general-purpose” microprocessors, one or more special-purpose microprocessors, and/or one or more application specific integrated circuits (ASICs), or some combination thereof. For example, the processor 74 may include one or more reduced instruction set (RISC) processors.

The memory device 76 may include a volatile memory, such as random-access memory (RAM), and/or a nonvolatile memory, such as read-only memory (ROM). The memory device 76 may store a variety of information and may be used for various purposes. For example, the memory device 76 may store processor-executable instructions (e.g., firmware or software) for the processor 74 to execute, such as instructions for receiving the bale wrap assembly code from the bale wrap assembly scanner 70, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for receiving the bale wrap assembly code from the bale wrap assembly scanner 70, etc.), and any other suitable data.

In the illustrated embodiment, the bale identification system 68 may include a user interface 78 communicatively coupled to the controller 72. The user interface 78 receives input from an operator and to provide information to the operator. The user interface 78 may include any suitable input device(s) for receiving input, such as a keyboard, a mouse, button(s), switch(es), knob(s), other suitable input device(s), or a combination thereof. In addition, the user interface 78 may include any suitable output device(s) for presenting information to the operator, such as speaker(s), indicator light(s), other suitable output device(s), or a combination thereof. In the illustrated embodiment, the user interface 78 includes a display 80 that presents visual information to the operator. In certain embodiments, the display 80 may include a touchscreen interface that receives input from the operator.

In certain embodiments, the controller 72 receives the bale wrap assembly code (e.g., a signal indicative of the bale wrap assembly code) from the bale wrap assembly scanner 70. As previously discussed, the bale wrap assembly scanner 70 scans the bale wrap assembly identifier 82 of each bale wrap assembly 66. In the illustrated embodiment, the bale wrap assembly identifier 82 is disposed on the shaft 84 of the bale wrap assembly 66 (e.g., image disposed on the shaft, RFID tag disposed on the shaft). For example, the bale wrap assembly scanner 70 may be positioned at a location within the agricultural harvester to scan the bale wrap assembly identifier 82 on the shaft 84 of the bale wrap assembly 66 as the bale wrap assembly 66 is loaded into the bale wrap assembly storage compartment. Furthermore, as previously discussed, the bale wrap assembly identifier 82 may include an image (e.g., bar code, QR code, data matrix) or an RFID tag. The bale wrap assembly identifier 82 includes data indicative of the bale wrap assembly code, and the bale wrap assembly code includes the bale wrap assembly identification code and, in certain embodiments, the bale wrap segment end index. While the bale wrap assembly identifier 82 is disposed on the shaft 84 of the bale wrap assembly 66 in the illustrated embodiment, in other embodiments, the bale wrap assembly identifier of the bale wrap assembly may be disposed on the bale wrap, or the bale wrap assembly identifier may be separate from the shaft and the bale wrap. For example, in certain embodiments (e.g., in embodiments in which the bale wrap assembly scanner is part of a handheld device), the bale wrap assembly identifier may be carried by the operator and scanned with the bale wrap assembly scanner (e.g., from a cab of the agricultural harvester). Furthermore, in certain embodiments, the bale wrap assembly identifier may be coupled to the shaft or to the bale wrap via a removable connection that enables the operator to remove and carry the bale wrap assembly identifier for subsequent scanning.

In certain embodiments, the bale wrap assembly code may also include additional information. For example, the bale wrap assembly code may include data indicative of a type of bale wrap, such as segmented or continuous. In addition, the bale wrap assembly code may include data indicative of the form of the bale wrap, such as a plastic film, an organic film, a net, or a series of twine segments. Furthermore, the bale wrap assembly code may include data indicative of the number of bale wrap segments of the bale wrap, the width of the bale wrap, the thickness of the bale wrap material, other suitable information, or a combination thereof.

Furthermore, for each bale wrap assembly 66, the controller 72 determines a respective bale wrap segment index for each bale wrap segment of the bale wrap 58 of the bale wrap assembly 66 based on the bale wrap segment end index and the order of bale wrap segment usage. The controller 72 also establishes a database having multiple entries. Each entry of the database corresponds to a respective bale wrap segment, and each entry includes the bale wrap assembly identification code for the respective bale wrap assembly, the respective bale wrap segment index, and bale wrap segment information (e.g., the type of bale wrap, the length of the bale wrap segment, the width of the bale wrap segment, the thickness of the bale wrap material, one or more other suitable properties of the bale wrap segment, or a combination thereof). In certain embodiments, the controller 72 stores the database (e.g., within a storage device of the controller).

The database enables a remote system 86 to retrieve the bale wrap segment information based on a bale wrap segment code received from a bale wrap scanner 88 of the remote system 86. As previously discussed, the bale wrap segment code includes the bale wrap assembly identification code and the respective bale wrap segment index. In the illustrated embodiment, each bale wrap segment 90 of the bale wrap 58 includes a bale wrap segment identifier 92 that facilitates identification of the wrapped bale. In certain embodiments, the bale wrap segment identifier 92 includes an image disposed on the bale wrap segment 90. For example, the image may be printed directly onto the bale wrap segment 90, the image may be printed onto a sticker applied to the bale wrap segment 90, or the image may be etched or engraved into the bale wrap segment 90. The image may include any suitable image (e.g., bar code, QR code, data matrix, etc.) that may be scanned by a suitable bale wrap scanner 88 of the remote system 86. Furthermore, in certain embodiments, the bale wrap segment identifier 92 may include an RFID tag disposed on the bale wrap segment 90. Each bale wrap segment identifier 92 includes data indicative of the respective bale wrap segment code. The bale wrap segment code includes the bale wrap assembly identification code and the respective bale wrap segment index, which in combination may uniquely identify the respective bale wrap segment or uniquely identify the respective bale wrap segment within a set of bale wrap segments. In certain embodiments, each bale wrap segment 90 may include multiple bale wrap segment identifiers 92 (e.g., spaced apart from one another, such that the bale wrap segment identifiers are disposed about the periphery of the wrapped bale), each having data indicative of the same bale wrap segment code.

The remote system 86 is separate from the agricultural harvester. In addition, the remote system 86 may be a handheld device used within a field, the remote system 86 may be a fixed device used within an agricultural product processing facility, or another suitable device. The bale wrap scanner 88 may include any suitable device(s) suitable for scanning the bale wrap segment identifier 92. For example, in embodiments in which the bale wrap segment identifier 92 includes an image (e.g., bar code, QR code, data matrix), the bale wrap scanner 88 may include an optical scanner. Furthermore, in embodiments in which the bale wrap segment identifier 92 includes an RFID tag, the bale wrap scanner 88 may include an RFID reader. As previously discussed, each bale wrap segment identifier 92 includes data indicative of a respective bale wrap segment code. In response to scanning the bale wrap segment identifier 92, the bale wrap scanner 88 outputs the respective bale wrap segment code (e.g., a signal indicative of the respective bale wrap segment code).

A controller of the remote system 86 (e.g., including a processor and a memory) receives the bale wrap segment code from the bale wrap scanner 88. As previously discussed, the bale wrap segment code includes the bale wrap assembly identification code and the respective bale wrap segment index. Accordingly, the bale wrap segment code enables the remote system to identify (e.g., uniquely identify) the bale wrap segment and, hence, the wrapped bale. In addition, the controller of the remote system 86 receives the database established by the controller 72 of the bale identification system 68. Accordingly, the controller of the remote system 86 may use the bale wrap assembly identification code and the bale wrap segment index to locate the entry corresponding to the respective bale wrap segment 90. As previously discussed, each entry of the database includes bale wrap segment information. Accordingly, the controller of the remote system 86 may retrieve the bale wrap segment information for the respective bale wrap segment 90 using the database and the bale wrap segment code.

In certain embodiments, the controller of the remote system 86 receives the database from the controller 72 of the bale identification system 68 via a wireless connection. For example, the bale identification system may include a transceiver communicatively coupled to the bale identification system controller, and the transceiver may output a signal indicative of the database. In addition, the remote system may include a transceiver communicatively coupled to the remote system controller, and the transceiver may receive the signal indicative of the database. Furthermore, in certain embodiments, the controller of the bale identification system may output a signal indicative of the database to the controller of the remote system via a wired connection (e.g., the remote system may be temporarily connected to the bale identification system with the wired connection). In addition, in certain embodiments, the bale identification system may include a removable media writer communicatively coupled to the bale identification system controller, and the removable media writer writes the database to a removable medium. In such embodiments, the remote system may include a removable media reader communicatively coupled to the remote system controller, and the removable media reader reads the removable medium, thereby providing the database to the remote system controller. Furthermore, in certain embodiments, the controller 72 of the bale identification system 68 outputs (e.g., via the respective transceiver) a signal indicative of the database to a remote server (e.g., a cloud-based server, etc.), and the remote server may receive the signal (e.g., via a respective transceiver) and store the database. In such embodiments, the controller of the remote system may receive a signal indicative of the database (e.g., via the respective transceiver) from the remote system.

In certain embodiments, the bale wrap assembly code does not include the bale wrap segment end index. In such embodiments, the controller 72 of the bale identification system 68 receives the bale wrap assembly code from the bale wrap assembly scanner 70, and the bale wrap assembly code includes the bale wrap assembly identification code. In addition, the controller 72 establishes a database having multiple entries. Each entry of the database corresponds to a respective bale wrap segment, and each entry includes the bale wrap assembly identification code for a respective bale wrap assembly, the bale wrap segment information, and at least one of an ejection time of the bale wrapped with the respective bale wrap segment or a location of ejection of the bale wrapped with the respective bale wrap segment. The database is sorted by the ejection time or the location of ejection. In certain embodiments, the controller 72 stores the database (e.g., within a storage device of the controller). The database enables the remote system 86 to retrieve the bale wrap segment information based on the bale wrap segment code received from the bale wrap scanner 88 of the remote system 86. The bale wrap segment code includes the bale wrap assembly identification code for the respective bale wrap assembly and a respective bale wrap segment index, and the bale wrap segment index corresponds to an order of the entries of the database. As previously discussed, the controller of the remote system 86 receives the database from the controller 72 of the bale identification system 68 via a wireless connection, a wired connection, or a removable medium.

In certain embodiments, the controller 72 of the bale identification system 68 determines the location of ejection of the wrapped bale based on feedback from a spatial locating device 93. The spatial locating device 93 is communicatively coupled to the controller 72, and the spatial locating device 93 may include any suitable device(s) that output a signal indicative of the position of the agricultural harvester within the field, such as a global positioning system (GPS) receiver, an inertial measurement unit (IMU), other suitable device(s), or a combination thereof. In response to determining the wrapped bale is ejected from the agricultural harvester (e.g., based on feedback from one or more sensors), the controller 72 may determine the location of the agricultural harvester based on feedback from the spatial locating device 93, and the controller 72 may store the location of ejection of the wrapped bale within a respective entry in the database. In embodiments in which the location of ejection of the wrapped bale is not stored within the database, the spatial locating device may be omitted.

The controller of the remote system 86 receives the bale wrap segment code from the bale wrap scanner 88. As previously discussed, the bale wrap segment code includes the bale wrap assembly identification code and the bale wrap segment index. Accordingly, the bale wrap segment code enables the remote system to identify (e.g., uniquely identify) the bale wrap segment and, hence, the wrapped bale. In addition, the controller of the remote system 86 receives the database established by the controller 72 of the bale identification system 68. Accordingly, the controller of the remote system 86 may use the bale wrap assembly identification code and the bale wrap segment index to locate the entry corresponding to the respective bale wrap segment 90. For example, the controller of the remote system 86 may use the bale wrap assembly identification code to identify a set of potential entries corresponding to the respective bale wrap assembly, and because the database is sorted by the ejection time or the location of ejection, the controller of the remote system 86 may match the bale wrap segment index to a corresponding entry of the set of potential entries based on the order of the entries (e.g., the first entry may correspond to the first bale wrap segment index, the second entry may correspond to the second bale wrap segment index, etc.). As previously discussed, each entry of the database includes the bale wrap segment information. Accordingly, the controller of the remote system 86 may retrieve the bale wrap segment information using the database and the bale wrap segment code.

In the illustrated embodiment, the bale identification system 68 includes a bale sensor assembly 94 communicatively coupled to the controller 72. The bale sensor assembly 94 monitors one or more properties of the bale 46 before the wrapped bale is ejected from the agricultural harvester. For example, the bale sensor assembly 94 may include a weight sensor that monitors a weight of the bale 46, a moisture sensor that monitors a moisture content of the agricultural product within the bale 46, a size sensor that monitors a diameter of the bale 46, other suitable sensor(s), or a combination thereof. The bale sensor assembly 94 outputs signal(s) indicative of the one or more properties of the bale, and the controller determines bale information for the bale 46, in which the bale information includes the one or more properties of the bale 46. When the controller 72 establishes the database, the controller 72 may include the bale information in the entry for the respective bale wrap segment 90. Accordingly, the bale information may be associated with each bale. While including the bale information in each entry of the database is disclosed above, in certain embodiments, the database may not include the bale information. In such embodiments, the bale sensor assembly may be omitted.

As previously discussed, in certain embodiments, the bale wrap identifier 92 includes an image disposed on the bale wrap segment 90, which includes data indicative of the respective bale wrap segment code. In such embodiments, the bale wrap segment code may include information indicative of one or more RFID tags and/or one or more near-field communication (NFC) tags coupled to the respective bale wrap segment 90. For example, the bale wrap segment code may include an identification code for each RFID/NFC tag coupled to the respective bale wrap segment 90. Accordingly, after scanning the bale wrap identifier 92, the remote system may be able to identify the bale by scanning any of the RFID/NFC tag(s) coupled to the respective bale wrap segment 90. In addition, the remote system 86 may add the identification code(s) for the RFID/NFC tag(s) to the respective entry of the database and/or establish an additional database that links the RFID identification code(s) to the respective bale wrap segment. While RFID and NFC tags are disclosed above, in certain embodiments, the bale wrap segment code may include information indicative of one or more other suitable type(s) of identifier(s), such as additional image(s) (e.g., bar code(s), QR code(s), data matrix/matrices), human-readable text, etc.

In certain embodiments, the controller 72 may instruct the user interface 78 to present information from the database on the display 80. For example, the controller 72 (e.g., in response to user input) may instruct the display 80 of the user interface 78 to present the database in a table form. The table may have rows corresponding to the entries of the database, and the table may have columns corresponding to the information within the entries. For example, in certain embodiments, the columns may include the bale wrap assembly identification code, the bale wrap segment index, the bale wrap segment information, and the bale information. Furthermore, in certain embodiments, the columns may include the bale wrap assembly identification code, the bale wrap segment information, the bale information, and at least one of the bale ejection time or the bale ejection location.

In the illustrated embodiment, the bale identification system 68 does not include a bale wrap scanner (e.g., scanner) that scans the bale wrap segment identifier 92. Accordingly, a bale wrap scanner may not be present on the agricultural harvester. Because the bale identification system 68 does not include a bale wrap scanner (e.g., scanner), the controller 72 of the bale identification system 68 does not receive the bale wrap segment code from a bale wrap scanner. Furthermore, in certain embodiments, the controller 72 of the bale identification system 68 does not receive the bale wrap segment code from any source.

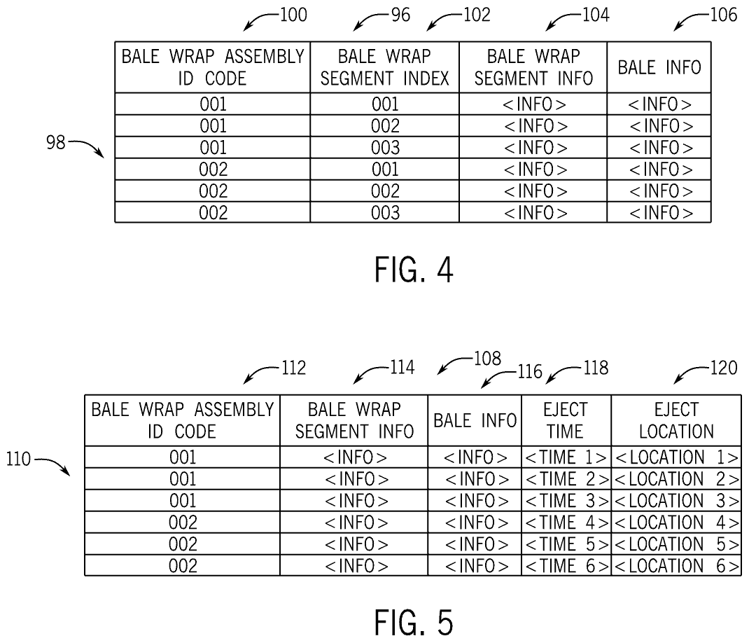

FIG. 4 is a table of an embodiment of a database 96 that may be established by the bale identification system of FIG. 3. In the illustrated embodiment, the database 96 includes multiple entries 98 (e.g., rows), in which each entry 98 corresponds to a respective bale wrap segment. In the illustrated embodiment, each entry 98 includes a bale wrap assembly identification code 100, a bale wrap segment index 102, bale wrap segment information 104, and bale information 106. The bale wrap assembly identification code 100 may uniquely identify the respective bale wrap assembly, or the bale wrap assembly identification code 100 may uniquely identify the respective bale wrap assembly within a set of bale wrap assemblies. In addition, the bale wrap segment index 102 is indicative of the position of the bale wrap segment within the bale wrap of the respective bale wrap assembly (e.g., first bale wrap segment, second bale wrap segment, third bale wrap segment, etc.). As previously discussed, the bale wrap segment information 104 may include the type of bale wrap, the length of the bale wrap segment, the width of the bale wrap segment, the thickness of the bale wrap material, one or more other suitable properties of the bale wrap segment, or a combination thereof. Furthermore, as previously discussed, the bale information 106 may include a weight of the bale, a moisture content of the agricultural product within the bale, a diameter of the bale, one or more other suitable bale properties, or a combination thereof. While the database 96 includes the bale information 106 in the illustrated embodiment, in other embodiments, the bale information may be omitted.

The database 96 includes multiple sets of entries, in which each set of entries corresponds to a respective bale wrap assembly. In addition, each entry of a respective set of entries corresponds to a respective bale wrap segment of a respective bale wrap assembly. In the illustrated embodiment, the database 96 includes data for two bale wrap assemblies (e.g., two sets of entries), in which each bale wrap assembly includes a bale wrap with three bale wrap segments. Accordingly, the database includes data for bale wrap segment 001 of bale wrap assembly 001, bale wrap segment 002 of bale wrap assembly 001, bale wrap segment 003 of bale wrap assembly 001, bale wrap segment 001 of bale wrap assembly 002, bale wrap segment 002 of bale wrap assembly 002, and bale wrap segment 003 of bale wrap assembly 002. However, in other embodiments the database may include data for more or fewer bale wrap assemblies, in which each bale wrap assembly may include a respective bale wrap with more or fewer bale wrap segments. Furthermore, while the database 96 is arranged as a table in the illustrated embodiment, in other embodiments, the database may have any other suitable configuration (e.g., blockchain, hierarchical, multiple tables, etc.).

As previously discussed, the database 96 may be established by the controller of the bale identification system disclosed above with reference to FIG. 3. For example, as each bale wrap assembly is loaded into the bale wrap assembly storage compartment, the controller may receive a respective bale wrap assembly code from the bale wrap assembly scanner. The bale wrap assembly scanner scans the respective bale wrap assembly identifier on the respective bale wrap assembly. The bale wrap assembly identifier includes data indicative of the bale wrap assembly code, and the bale wrap assembly code includes the bale wrap assembly identification code and a bale wrap segment end index (e.g., corresponding to a bale wrap segment index of the first or last bale wrap segment of the bale wrap assembly). Furthermore, the controller determines a respective bale wrap segment index for each bale wrap segment of the bale wrap assembly based on the bale wrap segment end index and an order of bale wrap segment usage. In addition, the controller establishes the database 96, in which each entry 98 of a respective set of entries corresponds to a respective bale wrap segment of the respective bale wrap assembly, and each entry includes the respective bale wrap assembly identification code, the respective bale wrap segment index, the respective bale wrap segment information, and, in certain embodiments, the respective bale information. The database enables the remote system to retrieve the respective bale wrap segment information and, in certain embodiments, the respective bale information based on the respective bale wrap segment code received by the bale wrap scanner of the remote system, in which the bale wrap segment code includes the respective bale wrap assembly identification code and the respective bale wrap segment index.

FIG. 5 is a table of another embodiment of a database 108 that may be established by the bale identification system of FIG. 3. In the illustrated embodiment, the database 108 includes multiple entries 110 (e.g., rows), in which each entry 110 corresponds to a respective bale wrap segment. In the illustrated embodiment, each entry 110 includes a bale wrap assembly identification code 112, bale wrap segment information 114, bale information 116, the ejection time 118 of the bale wrapped with the respective bale wrap segment, and the location of ejection 120 of the bale wrapped with the respective bale wrap segment. The bale wrap assembly identification code 112 may uniquely identify the respective bale wrap assembly, or the bale wrap assembly identification code 112 may uniquely identify the respective bale wrap assembly within a set of bale wrap assemblies. As previously discussed, the bale wrap segment information 114 may include the type of bale wrap, the length of the bale wrap segment, the width of the bale wrap segment, the thickness of the bale wrap material, one or more other suitable properties of the bale wrap segment, or a combination thereof. Furthermore, as previously discussed, the bale information 116 may include a weight of the bale, a moisture content of the agricultural product within the bale, a diameter of the bale, one or more other suitable bale properties, or a combination thereof. While the database 108 includes the bale information 116 in the illustrated embodiment, in other embodiments, the bale information may be omitted. Furthermore, while the database 108 includes both the bale ejection time 118 and the bale ejection location 120 in the illustrated embodiment, in other embodiments, the database may include only one of the bale ejection time 118 or the bale ejection location 120.

The database 108 includes multiple sets of entries, in which each set of entries corresponds to a respective bale wrap assembly. In addition, each entry of a respective set of entries corresponds to a respective bale wrap segment of a respective bale wrap assembly. In the illustrated embodiment, the database 108 includes data for two bale wrap assemblies (e.g., two sets of entries), in which each bale wrap assembly includes a bale wrap with three bale wrap segments. Accordingly, the database includes data for a bale wrap segment of bale wrap assembly 001 wrapped around a bale ejected at time 1 and at location 1, a bale wrap segment of bale wrap assembly 001 wrapped around a bale ejected at time 2 and at location 2, a bale wrap segment of bale wrap assembly 001 wrapped around a bale ejected at time 3 and at location 3, a bale wrap segment of bale wrap assembly 002 wrapped around a bale ejected at time 4 and at location 4, a bale wrap segment of bale wrap assembly 002 wrapped around a bale ejected at time 5 and at location 5, and a bale wrap segment of bale wrap assembly 002 wrapped around a bale ejected at time 6 and at location 6. However, in other embodiments, the database may include data for more or fewer bale wrap assemblies, in which each bale wrap assembly may include a respective bale wrap with more or fewer bale wrap segments. Furthermore, while the database 108 is arranged as a table in the illustrated embodiment, in other embodiments, the database may have any other suitable configuration (e.g., blockchain, hierarchical, multiple tables, etc.).

As previously discussed, the database 108 may be established by the controller of the bale identification system disclosed above with reference to FIG. 3. For example, as each bale wrap assembly is loaded into the bale wrap assembly storage compartment, the controller may receive a respective bale wrap assembly code from the bale wrap assembly scanner. The bale wrap assembly scanner scans the respective bale wrap assembly identifier on the respective bale wrap assembly. The bale wrap assembly identifier includes data indicative of the bale wrap assembly code, and the bale wrap assembly code includes the bale wrap assembly identification code. The controller establishes the database 108, in which each entry 110 corresponds to a respective bale wrap segment of the bale wrap of the respective bale wrap assembly, and each entry includes the bale wrap assembly identification code, the bale wrap segment information, and at least one of an ejection time of the bale wrapped with the respective bale wrap segment or a location of ejection of the bale wrapped with the respective bale wrap segment. The database is sorted by the ejection time 118 or the location of ejection 120. The database enables the remote system to retrieve the bale wrap segment information and, in certain embodiments, the respective bale information based on the bale wrap segment code received from the bale wrap scanner of the remote system. The bale wrap segment code includes the bale wrap assembly identification code and a respective bale wrap segment index, and the bale wrap segment index corresponds to an order of the entries of the database 108 with respect to a respective bale wrap assembly.

In certain embodiments, the bale wrap assembly scanner scans the bale wrap assembly identifier as the respective bale wrap assembly moves into the usage location (e.g., as the bale wrap assembly is loaded directly into the usage location, as the bale wrap assembly moves from the bale wrap assembly storage compartment to the usage location) or while the bale wrap assembly is within the usage location. In such embodiments, while the bale wrap assembly is in the usage location, the controller establishes entries in the database (e.g., the database disclosed above with reference to FIG. 4 or the database disclosed above with reference to FIG. 5) using the bale wrap assembly identification code of the bale wrap assembly in the usage location. Furthermore, in certain embodiments, the bale wrap assembly scanner scans the bale wrap assembly identifier as the respective bale wrap assembly is loaded into the bale wrap assembly storage compartment. In such embodiments, the controller may store the order of the bale wrap assemblies within the bale wrap assembly storage compartment (e.g., the order of the bale wrap assembly codes). Accordingly, as a bale wrap assembly moves from the bale wrap assembly storage compartment to the usage location, the controller may identify the bale wrap assembly based on the order, and while the bale wrap assembly is in the usage location, the controller may establish entries in the database (e.g., the database disclosed above with reference to FIG. 4 or the database disclosed above with reference to FIG. 5) using the bale wrap assembly identification code of the bale wrap assembly in the usage location.

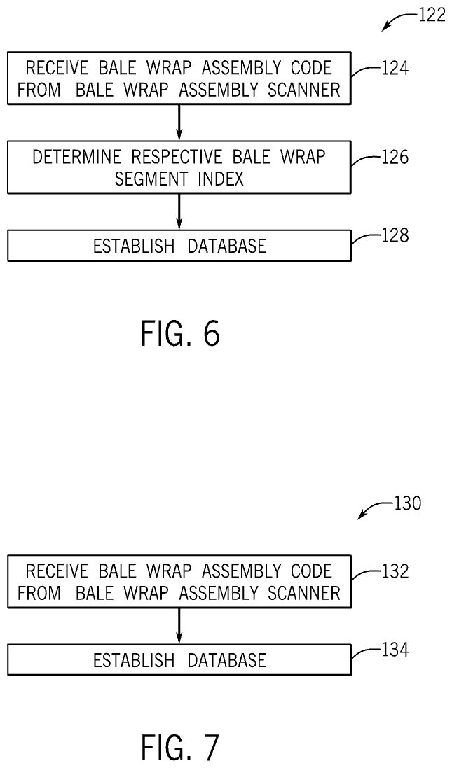

FIG. 6 is a flow diagram of an embodiment of a method 122 for facilitating bale identification. The method 122 may be performed by the controller disclosed above with reference to FIG. 3, by one or more other suitable controllers, or a combination thereof. Furthermore, the steps of the method 122 may be performed in the order disclosed below or in any other suitable order. In addition, in certain embodiments, one or more steps of the method 122 may be omitted, and/or the method may include one or more additional steps.

In the illustrated embodiment, the method 122 includes receiving a bale wrap assembly code from a bale wrap assembly scanner, as represented by block 124. As previously discussed, the bale wrap assembly scanner scans a bale wrap assembly identifier of a bale wrap assembly. In addition, the bale wrap assembly identifier includes data indicative of the bale wrap assembly code, and the bale wrap assembly code includes a bale wrap assembly identification code and a bale wrap segment end index.

Furthermore, the method 122 includes determining a respective bale wrap segment index for each bale wrap segment of the bale wrap assembly based on the bale wrap segment end index and an order of the bale wrap segment usage, as represented by block 126. The method 122 also includes establishing a database having multiple entries, as represented by block 128. As previously discussed, each entry of the database corresponds to a respective bale wrap segment, and each entry of the database includes the bale wrap assembly identification code, the respective bale wrap segment index, and bale wrap segment information. The database enables a remote system to retrieve the bale wrap segment information based on a bale wrap segment code received from a bale wrap scanner of the remote system, and the bale wrap segment code includes the bale wrap assembly identification code and the respective bale wrap segment index. In certain embodiments, the method does not include receiving the bale wrap segment code.

FIG. 7 is a flow diagram of another embodiment of a method 130 for facilitating bale identification. The method 130 may be performed by the controller disclosed above with reference to FIG. 3, by one or more other suitable controllers, or a combination thereof. Furthermore, the steps of the method 130 may be performed in the order disclosed below or in any other suitable order. In addition, in certain embodiments, one or more steps of the method 130 may be omitted, and/or the method may include one or more additional steps.

In the illustrated embodiment, the method 130 includes receiving a bale wrap assembly code from a bale wrap assembly scanner, as represented by block 132. As previously discussed, the bale wrap assembly scanner scans a bale wrap assembly identifier of a bale wrap assembly. The bale wrap assembly identifier includes data indicative of the bale wrap assembly code, and the bale wrap assembly code includes a bale wrap assembly identification code.

Furthermore, the method 130 includes establishing a database having multiple entries, as represented by block 134. Each entry of the database corresponds to a respective bale wrap segment, and each entry of the database includes the bale wrap assembly identification code, bale wrap segment information, and at least one of an ejection time of a bale wrapped with the respective bale wrap segment or a location of ejection of the bale wrapped with the respective bale wrap segment. Furthermore, the database is sorted by the ejection time or the location of ejection. The database enables a remote system to retrieve the bale wrap segment information based on a bale wrap segment code received from a bale wrap scanner of the remote system, and the bale wrap segment code includes the bale wrap assembly identification code and a respective bale wrap segment index. Furthermore, the bale wrap segment index corresponds to an order of the entries of the database. In certain embodiments, the method does not include receiving the bale wrap segment code.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A bale identification system of an agricultural harvester, comprising:
a controller comprising a processor and a memory, wherein the controller:
receives a bale wrap assembly code from a bale wrap assembly scanner, wherein the bale wrap assembly scanner scans a bale wrap assembly identifier of a bale wrap assembly, the bale wrap assembly identifier comprises data indicative of the bale wrap assembly code, and the bale wrap assembly code comprises a bale wrap assembly identification code and a bale wrap segment end index;
determines a respective bale wrap segment index for each bale wrap segment of a plurality of bale wrap segments of the bale wrap assembly based on the bale wrap segment end index and an order of bale wrap segment usage; and
establishes a database comprising a plurality of entries, wherein each entry of the plurality of entries corresponds to a respective bale wrap segment of the plurality of bale wrap segments, and each entry of the plurality of entries comprises the bale wrap assembly identification code, the respective bale wrap segment index, and bale wrap segment information.

2. The bale identification system of claim 1, wherein the bale wrap assembly scanner is positioned at a location within the agricultural harvester to scan the bale wrap assembly identifier as the bale wrap assembly is loaded into a bale wrap assembly storage compartment of the agricultural harvester.

3. The bale identification system of claim 1, wherein the bale wrap assembly identifier comprises an image or a radio frequency identification (RFID) tag.

4. The bale identification system of claim 1, wherein the database is configured to enable a remote system to retrieve the bale wrap segment information based on a bale wrap segment code received from a bale wrap scanner of the remote system, and the bale wrap segment code comprises the bale wrap assembly identification code and the respective bale wrap segment index.

5. The bale identification system of claim 4, wherein the bale identification system does not comprise a scanner that scans a bale wrap segment identifier, the bale wrap segment identifier comprises data indicative of the bale wrap segment code, and the controller does not receive the bale wrap segment code.

6. The bale identification system of claim 4, wherein the bale wrap segment code comprises information related to a radio frequency identification (RFID) tag coupled to the respective bale wrap segment.

7. The bale identification system of claim 1, wherein each entry of the plurality of entries comprises bale information corresponding to a bale wrapped by the respective bale wrap segment.

8. A method for facilitating bale identification, comprising:
receiving, via a controller comprising a processor and a memory, a bale wrap assembly code from a bale wrap assembly scanner, wherein the bale wrap assembly scanner scans a bale wrap assembly identifier of a bale wrap assembly, the bale wrap assembly identifier comprises data indicative of the bale wrap assembly code, and the bale wrap assembly code comprises a bale wrap assembly identification code and a bale wrap segment end index;
determining, via the controller, a respective bale wrap segment index for each bale wrap segment of a plurality of bale wrap segments of the bale wrap assembly based on the bale wrap segment end index and an order of bale wrap segment usage; and
establishing, via the controller, a database comprising a plurality of entries, wherein each entry of the plurality of entries corresponds to a respective bale wrap segment of the plurality of bale wrap segments, and each entry of the plurality of entries comprises the bale wrap assembly identification code, the respective bale wrap segment index, and bale wrap segment information.

9. The method of claim 8, wherein receiving the bale wrap assembly code comprises receiving the bale wrap assembly code as the bale wrap assembly is loaded into a bale wrap assembly storage compartment of the agricultural harvester.

10. The method of claim 8, wherein the bale wrap assembly identifier comprises an image or a radio frequency identification (RFID) tag.

11. The method of claim 8, wherein the database is configured to enable a remote system to retrieve the bale wrap segment information based on a bale wrap segment code received from a bale wrap scanner of the remote system, and the bale wrap segment code comprises the bale wrap assembly identification code and the respective bale wrap segment index.

12. The method of claim 11, wherein the method does not comprise receiving the bale wrap segment code.

13. The method of claim 8, wherein each entry of the plurality of entries comprises bale information corresponding to a bale wrapped by the respective bale wrap segment.

14. A bale identification system for an agricultural harvester, comprising:
a controller comprising a processor and a memory, wherein the controller:
receives a bale wrap assembly code from a bale wrap assembly scanner, wherein the bale wrap assembly scanner scans a bale wrap assembly identifier of a bale wrap assembly, the bale wrap assembly identifier comprises data indicative of the bale wrap assembly code, and the bale wrap assembly code comprises a bale wrap assembly identification code; and
establishes a database comprising a plurality of entries, wherein each entry of the plurality of entries corresponds to a respective bale wrap segment of a plurality of bale wrap segments of the bale wrap assembly, each entry of the plurality of entries comprises the bale wrap assembly identification code, bale wrap segment information, and at least one of an ejection time of a bale wrapped with the respective bale wrap segment or a location of ejection of the bale wrapped with the respective bale wrap segment, the database is sorted by the ejection time or the location of ejection, the database enables a remote system to retrieve the bale wrap segment information based on a bale wrap segment code received from a bale wrap scanner of the remote system, the bale wrap segment code comprises the bale wrap assembly identification code and a respective bale wrap segment index, and the bale wrap segment index corresponds to an order of the plurality of entries.

15. The bale identification system of claim 14, wherein the bale wrap assembly scanner is positioned at a location within the agricultural harvester to scan the bale wrap assembly identifier as the bale wrap assembly is loaded into a bale wrap assembly storage compartment of the agricultural harvester.

16. The bale identification system of claim 14, wherein the bale wrap assembly identifier comprises an image or a radio frequency identification (RFID) tag.

17. The bale identification system of claim 16, wherein the image comprises a bar code, a quick response (QR) code, or a data matrix.

18. The bale identification system of claim 14, wherein each entry of the plurality of entries comprises bale information corresponding to the bale wrapped by the respective bale wrap segment.

19. The bale identification system of claim 14, wherein the controller does not receive the bale wrap segment code.

20. The bale identification system of claim 14, wherein the bale wrap segment code comprises information related to a radio frequency identification (RFID) tag coupled to the respective bale wrap segment.
